(19) United States
(12) Patent Application Publication
(10) Pub. No.: US 2006/0202864 A1
(43) Pub. Date: Sep. 14, 2006

(54) Airport navigation light unit and system

(76) Inventor: Nils Pirschel, Hausen (DE)

Correspondence Address: Siemens Corporation;Intellectual Property Department, 170 Wood Avenue South, Iselin, NJ, 08830, US

(21) Appl. No.: 10/549,020

(22) PCT Filed: Mar. 19, 2004
(86) PCT No.: PCT/EP04/02926

§ 371 Date: Sep. 15, 2005

(30) Foreign Application Priority Data
Mar. 20, 2003 (EP) 03006362.2

(51) Int. Cl. G08B 21/00

(52) U.S. Cl. 340/945

(57) ABSTRACT

An airport navigation light unit wherein connection elements for supply lines, a lighting device, a sensor device, a switching device and a communication device are provided in a base body The switching device and the communication device are connected to the connection elements. The communication device switches the switching device, according to control signals which are transmitted via the supply lines, which switches the lighting device on to the connection elements. The sensor device detects a state prevailing outside the airport navigation light unit and transmits it to the communication device which determines a useful signal therefrom which it feeds to the supply lines. The control signals and the useful signal are transmitted as OFDM signals via the supply lines. An airport navigation light system comprises a plurality of said airport navigation units.

### CROSS REFERENCE TO RELATED APPLICATIONS

This application claims priority to the European application No. 03006362.2, filed Mar. 20, 2003 and to the International Application No. PCT/EP2004/002926, filed Mar. 19, 2004 which are incorporated by reference herein in their entirety.

### FIELD OF INVENTION

The present invention relates to an airport navigation light unit comprising a base body in which connection elements for connecting supply lines, a lighting device, a sensor device, a switching device and a communication device are arranged. The present invention relates furthermore to an airport navigation light system comprising a power supply device, a central communication unit assigned to said power supply device and a plurality of airport navigation light units, the airport navigation light units being connected via supply lines to the power supply device.

### BACKGROUND OF INVENTION

Airport navigation light units of this type and airport navigation light systems of this type are generally known.

Thus, from DE 101 04 950 A1, for example, an airport navigation light unit of this type is known in which the switching device and the communication device are connected to the connection elements. The switching device can be switched by the communication device according to control signals which are transmitted to the communication device via the supply lines. As a result, the lighting device can be switched on to the connection elements by means of the switching device. An internal operating state of the lighting device can be detected by means of the sensor device and transmitted to the communication device. The raw signal can then be fed to the supply lines. Also known from this publication is an associated airport navigation light system in which the central communication unit is also connected to the supply lines.

Such an airport navigation light unit is also known from DE 199 49 737 A1. In the case of this airport navigation light unit, only the switching device is connected to the connection elements. According to control signals transmitted via a separate communication path, the switching unit can be switched by the communication device, so the lighting device can be switched on to the connection elements by means of the switching device. A state prevailing outside the airport navigation light unit can be detected by means of the sensor device and transmitted as a raw signal to the communication device. The raw signal can be evaluated by the communication device and a useful signal determined therefrom transmitted via the separate communication path. A corresponding airport navigation light system is also known from this publication.

An airport navigation light unit of this type is also disclosed in the earlier German patent application 102 33 437.4, not subject to prior publication at the time of filing. In the case of this airport navigation light unit, both the switching device and the communication device are connected to the connection elements. The switching device can be switched by the communication device according to control signals which are transmitted to the communication device via the supply line, so the lighting device can be switched on to the connection elements by means of the switching device. A state prevailing inside the airport navigation light unit can be detected by means of the sensor device and transmitted to the communication device. The state can relate in particular to the operating state of the lighting device. The raw signal can be fed by the communication device to the supply lines. The control signals and the useful signal are transmitted as OFDM signals via the supply lines.

In the aforementioned patent application, not subject to prior publication, there is also disclosed an airport navigation light system comprising a power supply device, a central communication unit assigned to the power supply device and a plurality of airport navigation light units. The airport navigation light units are connected via the same supply lines both to the power supply device and to the central communication unit.

From U.S. Pat. No. 5,426,429 an airport navigation light unit is known comprising a base body which has connection elements for connecting supply lines and in which a lighting device, a switching device and a communication device are arranged. The switching device and the communication device are connected to the connection elements. The switching device can be switched by the communication device according to control signals transmitted via the supply lines to the communication device, so the lighting device can be switched on to the connection elements by means of the switching device. A sensor device can be connected to the airport navigation light unit, by means of which sensor device a state prevailing outs ide the airport navigation light unit can be detected and transmitted as a raw signal to the communication device. The raw signal can be evaluated by the communication device and a useful signal determined therefrom can be fed to the supply lines.

### SUMMARY OF INVENTION

An object of the present invention is to create an airport navigation light unit and an airport navigation light system corresponding herewith, in which complex states prevailing outside the airport navigation light unit can also be detected simply and yet safely and reliably and can be transmitted to a central communication unit superordinate to the airport navigation light unit. In the event that the airport navigation light unit is connected via a transformer to a series power supply circuit, data transmission should essentially be independent of the length of a spur line from the transformer to the airport navigation light unit.

The object is achieved by the claims.

If the OFDM signals can be transmitted in a frequency range between 20 and 160 kHz, the airport navigation light unit operates particularly reliably, for below a lower threshold frequency of 20 kHz disruptions occur through thyristor-controlled current regulators. Above an upper threshold frequency of 160 kHz, the low-pass behavior of the transmission medium (cable, transformer) hampers communication. The OFDM signals can be transmitted in a plurality of non-overlapping frequency bands. Each frequency band has a bandwidth. If the communication device is fashioned such that the bandwidth of the frequency bands can be parameterized, the bandwidth used can be adapted to the data throughput required and to the data security required.

If the communication device is fashioned such that a signal transmission request can be fed by it to the supply lines, active reporting of a signal transmission is possible (in contrast to a purely passive response to a request by the central communication unit).

Alternatively or additionally, it is also possible for the communication device to be fashioned such that the useful signal can be fed by it to the supply lines unrequested.

If the communication device has an intelligent programmable unit, e.g. a microprocessor or a microcontroller, the communication device and with it the airport navigation light unit can be flexibly adapted and/or updated.

If the communication device determines from the raw signal as a useful signal at least the presence or absence of an object, in particular a metal object, e.g. an aircraft, the airport navigation light unit is designed for a particularly frequent application case. More detailed information about the object, e.g. a classification or type-coding of the object, a speed measurement or a distance measurement, can optionally also be provided.

If the sensor device has at least one magnetic-field sensor and/or at least one radar sensor, it can be manufactured particularly reliably and cost-effectively.

Alternatively or additionally, the communication device can also determine using the raw signal as a useful signal an—in particular meteorological—environmental characteristic, e.g. the temperature, the wind speed or precipitation.

If a transformer is connected upstream of the connection elements, the airport navigation light unit can advantageously be connected to a series power supply circuit. Due to the use of OFDM signals for data transmissions, a spur line from the transformer to the airport navigation light unit can have a line length exceeding 5 meters. In particular, the spur line can be up to 200 meters long.

### BRIEF DESCRIPTION OF THE DRAWINGS

Further advantages and details will emerge from the description hereinbelow of an exemplary embodiment in conjunction with the drawings, in which

FIG. 1 shows a schematic diagram of an airport navigation light unit and

FIGS. 2-4 each show a schematic diagram of an airport navigation light unit.

### DETAILED DESCRIPTION OF INVENTION

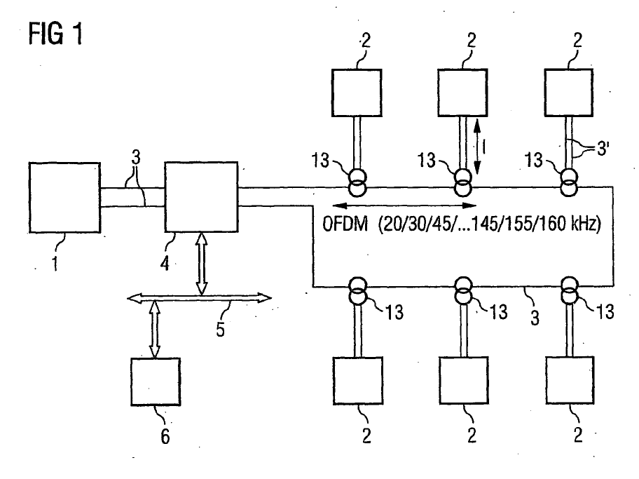

According to FIG. 1, an airport navigation light system has a power supply device 1 and a plurality of airport navigation light units 2. The airport navigation light units 2 are connected to the power supply device 1 via supply lines 3. The supply lines 3 form a series power supply circuit to which the airport navigation light units 2 are connected. The supply lines 3 could, however, also form a parallel power circuit.

A central communication unit 4 is assigned to the power supply device 1. The central communication unit 4 is looped in to the supply lines 3. The airport navigation light units 2 are therefore connected via the same supply lines 3 to both the power supply device 1 and the central communication unit 4.

The central communication unit 4 is connected, e.g. via a local connecting network 5, to a master computer 6. The central communication unit 4 receives from the master computer 6 firstly setpoint inputs which it forwards to the airport navigation light units 2. Secondly, it receives from the airport navigation light units 2 status reports which it forwards to the master computer 6. The master computer 6 is in this way able to effect an airport management system, as described, for example, in DE 101 04 950 A1, DE 199 49 737 A1 or EP 0 883 873 B1.

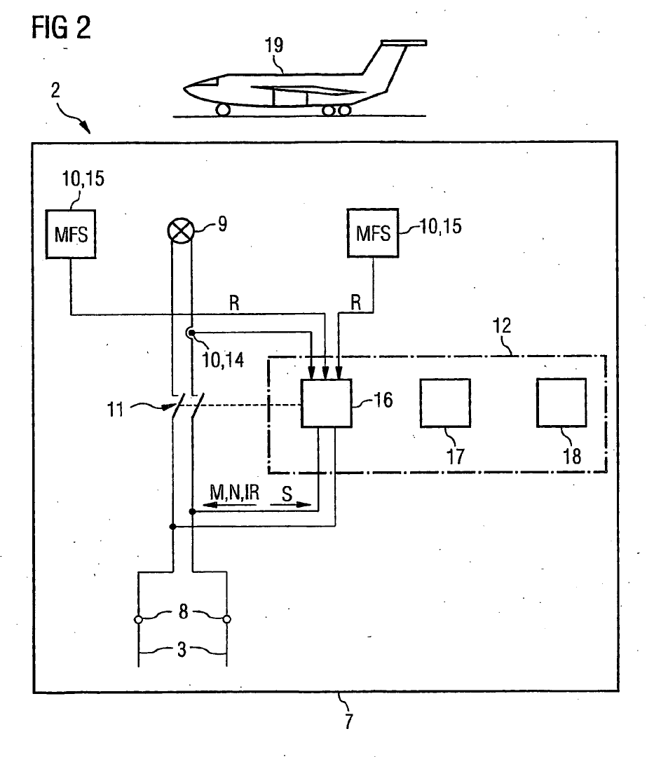

According to FIG. 2, each airport navigation light unit 2 has a base body 7. Connection elements 8 are arranged in the base body 7 for connecting the supply lines 3, a lighting device 9, a sensor device 10, a switching device 11 and a communication device 12. The lighting device 9 has at least one, optionally also a plurality of lights. The sensor device has at least one sensor. The switching device 11 has one switch per light outlet from the light.

The switching device 11 and the communication device 12 are connected to the connection elements 8. A transformer 13 is connected upstream of the connection elements 8. The transformer 13 enables the connection, as shown in FIG. 1, of the airport navigation light units 2 to the series power supply circuit. The connection is effected via spur lines 3′ which have a line length 1. The line length 1 can be greater than 5 meters, in particular also greater than 10 meters. In a particular case, it can be up to 200 meters but, where possible, 100 to 150 meters should not be exceeded.

Control signals S can be transmitted by the central communication unit 4 via the supply lines 3 to the communication device 12. The transmission of control signals S is effected, as can be seen from FIGS. 1 and 2, as an OFDM signal, to be precise preferably in a frequency range between 20 and 160 kHz. A lower threshold frequency of 30, or better 45 or 55 kHz, should not be undershot and an upper threshold frequency of 145 or 155 kHz should not be exceeded.

The switching device 11 is switched by the communication device 12 according to the control signals S transmitted. In this way, the lighting device 9 can be connected to or separated from the connection elements 8 by means of the switching device 11. Here, the switching device 11 is preferably fashioned as an electronic switching device 11. In principle, however, it would also be possible for it to be fashioned as an electromechanical switch 11.

The sensor device 10 has at least one sensor 14 and at least one sensor 15. By means of the sensor 14, an internal state of the airport navigation light unit 2 can be detected and transmitted to the communication device 12. For example, by means of the sensor 14 it can be detected whether current is flowing through the lighting device 9 or not. In conjunction with the desired switching state of the lighting device 9, which desired state is known to the communication device 12 due to the transmitted control signal S, this communication device 12 can consequently determine whether the lighting device 9 is defective. A corresponding feedback message M (e.g. switched on—switched off—flashing—defective) can optionally be transmitted by the communication device 12 via the supply lines 3 to the central communication unit 4. The feedback message M also is optionally transmitted as an OFDM signal via the supply lines 3. The frequency range in this case is preferably the same as that used in the transmission of control signals S.

By means of the sensor 15, a state which prevails out side the airport navigation light unit 2 can be detected. This signal can be transmitted as a raw signal R to the communication device 12. The raw signal R can be evaluated by this communication device 12 and a useful signal N determined therefrom. The useful signal N can be fed in the same manner as the feedback message M, i.e. as an OFDM signal in the frequency range between 30 (35, 45) and 160 (155, 145) kHz, to the supply lines 3 and can in this way be transmitted to the central communication unit 4.

The communication device 12 contains according to FIG. 2 an intelligent programmable unit 16, e.g. a microprocessor or a microcontroller. A program memory 17 and a working memory 18 are assigned to the intelligent unit 16. The program memory 17 is a read-only memory. It is preferably electrically erasable and re-writable. Reprogramming of the communication device 12 is possible by this means—possibly even via the supply lines 3. The working memory 18 can be a—possibly buffered—volatile memory (RAM).

The transmission of OFDM signals is effected in a plurality of frequency bands which each have a bandwidth, but do not overlap. In particular, the bandwidth of the frequency bands is determined here by the program filed in the program memory 17. The communication device 12 is thus fashioned such that the bandwidth of the frequency bands can be parameterized.

According to FIG. 2, the airport navigation light unit 2 has two sensors 15 which are fashioned according to FIG. 2 as magnetic-field sensors (MFS). The presence or absence of an object 19 can be detected in a simple manner by means of the magnetic-field sensors 15 shown in FIG. 2—particularly if the airport navigation light unit 2 is installed in a take-off runway, a landing runway or a taxiway of an airport. This applies quite particularly when the object 19 is a metal object, e.g. an aircraft 19 or a motor vehicle. However, the detection of alien objects 19 on landing runways and taxiways is also possible.

The communication device 12 is therefore preferably programmed such that it determines from the raw signal R a useful signal N that indicates this presence or absence. Given correspondingly precise evaluation of the raw signal R, a finer differentiation of the useful signal N can optionally also be made. For example, a type classification (A310—B737—DC10—motor vehicle—other object) can be carried out. Due to the presence of two sensors 15, the speed of the object 19 when crossing the airport navigation light unit 2 can also be determined.

If the airport navigation light units 2 operate on the basis of synchronization on a shared time base, it is also possible to transmit, together with the detection of an object 19, the respective detection time to the central communication unit 4. In this case, determination of the speed of the object 19 is also possible when the airport navigation light units 2 have only a single magnetic-field sensor.

The magnetic-field sensors 15 detect the geomagnetic field and its distortion along at least one axis. The detection axis in this case is vertical. In the case of dual-axis detection, the geomagnetic field is preferably additionally detected transversely to the direction of taxiing. Regarding the reasons for this, the reader is referred to EP 1 193 662 A1 (see FIG. 5 there).

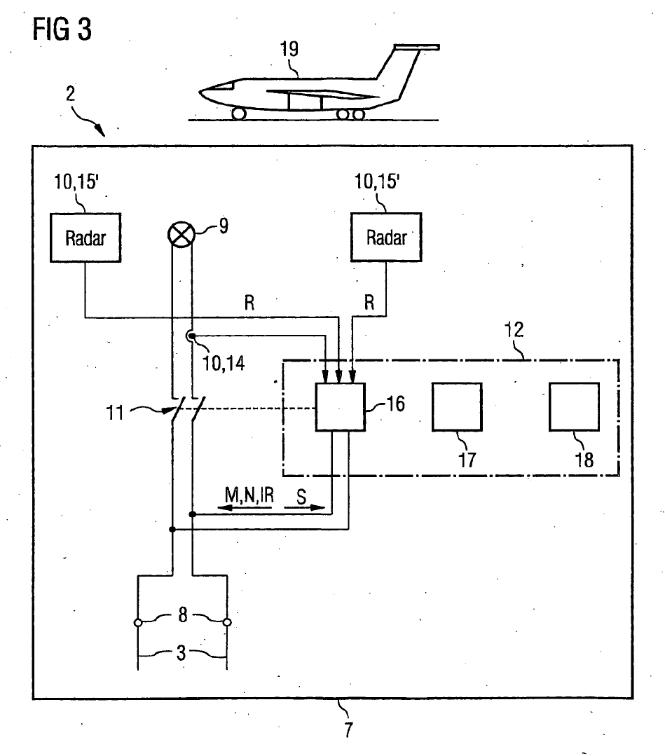

FIG. 3 shows a similar airport navigation light unit 2 to that shown in FIG. 2. By contrast with FIG. 2, however, the sensor device 10 has an external sensor 15′ which is fashioned as a radar sensor. In other respects, the mode of operation of the airport navigation light unit 2 shown in FIG. 3 is identical to that shown in FIG. 2.

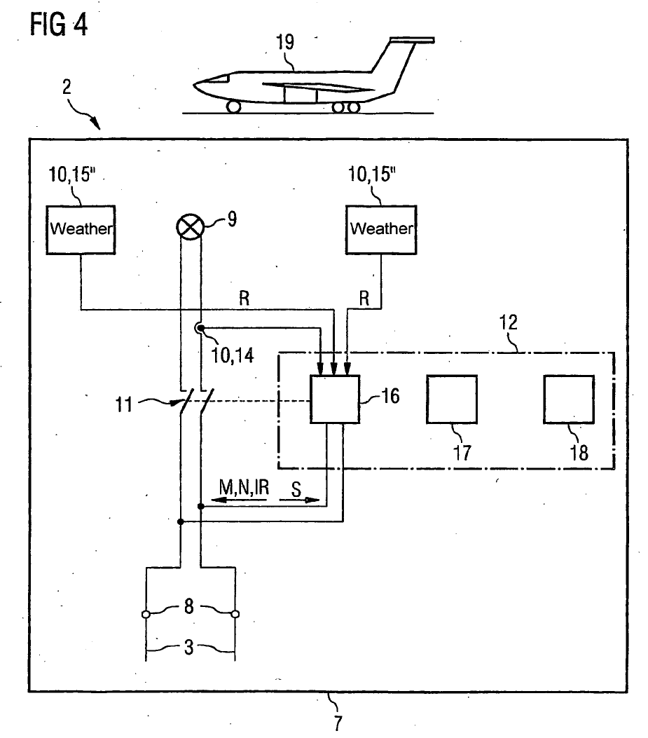

As an alternative to or in addition to detecting an object 19 according to FIGS. 2 and 3, the airport navigation light unit 2—see also FIG. 4—can also contain a further external sensor 15″. Its raw signal R is evaluated by the communication device 12 in such a way that this communication device determines a useful signal N therefrom in respect of a meteorological environmental characteristic. The meteorological environmental characteristic can, for example, be the temperature, the wind speed, precipitation (e.g. rain, snow) or visibility conditions (e.g. day/night/fog).

Other characteristics can also—alternatively or additionally—be detected by means of the sensor device 10. Examples of such characteristics are vibrations, noises, air or ground humidity and internal states of the airport navigation light unit 2. In particular also, special sensors can be used for this. Furthermore, the detection of objects can also be effected with sensors other than radar or magnetic-field sensors. For example, optical sensors (especially cameras) can be used.

In all cases, i.e. both in the embodiment according to FIG. 2 and in the embodiment according to FIG. 3 or the embodiment according to FIG. 4, the evaluation and categorization of the raw signal is thus effected by the communication device 12. The evaluation result is then transmitted by the communication device 12 via the supply lines 3 to the central communication unit 4.

In the case of prior-art airport navigation light systems it has to date been usual for the airport navigation light units 2 to be purely passive components. The communication devices 12 are thus specifically addressed by the central communication unit 4 and then respond to this addressing.

In contrast to this, the communication devices 12 according to FIGS. 2 to 4 are fashioned such that they can also feed a signal transmission request e.g. in the form of an interrupt request IR, to the supply lines 3. If, for example, one of the communication devices 12 notices a defect in the lighting device 9, it feeds the signal transmission request IR to the supply lines 3. The signal transmission request IR is received and evaluated by the central communication unit 4. It can therefore in the next step address in a targeted manner the communication device 12 which has sent the signal transmission request IR. The sending communication device 12 can optionally also transmit, in addition to its address, a code, from which the central communication unit can recognize the type of signals to be transmitted. For example, different codes can be used for recognizing an object 19, for modifying a meteorological identifying characteristic or for modifying an internal state of an airport navigation light unit (e.g. failure of the lighting device 9).

It is even possible for the communication devices 12 to feed not only an interrupt request IR but immediately the useful signal N itself to the supply lines. In this case, however, collision monitoring, which is generally known from computer networks, must be carried out.

The transformers 13 are optimized for operating in the series power supply circuit. They are essentially designed for optimizing power transmission, but not for optimizing signal transmission. They therefore dampen the transmitted signals S, M, N, IR relatively severely. For this reason, the communication devices 12 preferably have repeaters for signal conditioning and amplification and means for measuring the reception strength and quality of the transmitted signals S, M, N, IR. The reception strength and quality is also preferably transmitted via the supply lines 3 to the central communication unit 4. The central communication unit 4 thus constantly receives a picture of the overall communication system. By evaluating the information transmitted about transmission quality and signal strength, the central communication unit 4 is consequently able to configure the overall communication system dynamically—optionally even optimally for each individual transmission operation. In particular, the central communication unit 4 can, by transmitting corresponding control signals S, stipulate which of the communication devices 12 is to perform repeater functions in each case and which not. In this way, adequate transmission quality in the communication system is constantly ensured. At the same time, the power outlay needed for this, as well as crosstalk behavior and background noise, can be optimized through dynamic adaptation of the communication network.

1.-12. (canceled)

13. An Airport navigation light unit, comprising:
a base body;
connection elements arranged in the base body for connecting supply lines;
a lighting device;
a sensor device;
a switching device; and
a communication device, the switching device and the communication device connected to the connection elements, wherein
the switching device is configured to be switched by the communication device based on control signals transmitted to the communication device via the supply lines for switching the lighting device to the connection elements using the switching device,
the sensor device is configured to detect a state prevailing outside the airport navigation light unit and to transmit the detected stated in form of a raw signal to the communication device,
the communication device is configured to evaluate the raw signal, to generate a wanted signal based on the evaluated raw signal, and to feed the wanted signal to the supply line, and
the control signals and the wanted signal are transmitted via the supply lines in the form of OFDM signals.

14. The Airport navigation light unit according to claim 13, wherein the OFDM signals are transmitted in a frequency range between 20 and 160 kHz.

15. The Airport navigation light unit according to claim 13, wherein the OFDM signals are transmitted in a plurality of non-overlapping frequency bands, and the communication device is configured to parametrize the bandwidth of the frequency bands.

16. The Airport navigation light unit according to claim 13, wherein the communication device is further configured to feed a signal transmission request to the supply lines.

17. The Airport navigation light unit according to claim 13, wherein the communication device is further configured to unsolicitedly feed the wanted signal to the supply lines.

18. The Airport navigation light unit according to claim 13, wherein the communication device includes an intelligent programmable unit.

19. The Airport navigation light unit according to claim 18, wherein the intelligent programmable unit is a microprocessor or a microcontroller.

20. The Airport navigation light unit according to claim 13, wherein the wanted signal-includes information on the presence or absence of an object.

21. The Airport navigation light unit according to claim 20, wherein the object is a metal object.

22. The Airport navigation light unit according to claim 21, wherein the metal object is an aircraft.

23. The Airport navigation light unit according to claim 13, wherein the sensor device includes a magnetic-field sensor or a radar sensor.

24. The Airport navigation light unit according to claim 13, wherein the wanted signal includes an environmental characteristic.

25. The Airport navigation light unit according to claim 24, wherein the environmental characteristic is a meteorological characteristic.

26. The Airport navigation light unit according to claim 25, wherein the meteorological characteristic is an ambient temperature, a wind speed or a current precipitation.

27. The Airport navigation light unit according to claim 13, further comprising a transformer connected upstream of the connection elements.

28. An Airport navigation light system, comprising:
a power supply device;
a central communication unit assigned to the power supply device; and
a plurality of airport navigation light units, each navigation light unit comprising:
a base body;
connection elements arranged in the base body for connecting supply lines;
a lighting device;
a sensor device;
a switching device; and
a communication device, the switching device and the communication device connected to the connection elements, wherein
the switching device is configured to be switched by the communication device based on control signals transmitted to the communication device via the supply lines for switching the lighting device to the connection elements using the switching device,
the sensor device is configured to detect a state prevailing outside the airport navigation light unit and to transmit the detected stated in form of a raw signal to the communication device,
the communication device is configured to evaluate the raw signal, to generate a wanted signal based on the evaluated raw signal, and to feed the wanted signal to the supply line, and
the control signals and the wanted signal are transmitted via the supply lin es in the form of OFDM signals, wherein the airport navigation light units are connected both to the power supply device and to the central communication unit using the same supply lines.

29. The Airport navigation light system according to claim 28, wherein
the supply lines form a series power supply circuit,
the airport navigation light units are connected to the series power supply circuit via transformers and spur lines, and
at least one of the spur lines has a line length between 5 and 200 meters.
